(19) United States
(12) Patent Application Publication
(10) Pub. No.: US 2007/0137941 A1
(43) Pub. Date: Jun. 21, 2007

(54) Grease gun

(76) Inventor: Hsueh Chin Chang, Taichung City (TW)

Correspondence Address: Hsueh Chin Chang, Sec. 1, No. 212 Wunsin Rd., Taichung City, 5F-2, TW

(21) Appl. No.: 11/257,468

(22) Filed: Oct. 25, 2005

(30) Foreign Application Priority Data
Sep. 26, 2005 (TW) 094216529

(51) Int. Cl. F16N 21/00

(52) U.S. Cl. 184/105.2

(57) ABSTRACT

A grease gun includes a hollow body having a joint formed on the middle section of the hollow body and a grease container is mounted to the joint for containing grease. A pump unit is mounted to the rear end of the hollow body and an outlet unit is mounted to the front end of the hollow body, whereby the pump unit is operated to form a pressure difference between the hollow body and the grease container such that the grease in the grease container is drawn into the hollow body from the grease container and discharged via the outlet unit.

### BACKGROUND OF THE INVENTION

1. Field of the Invention

The present invention relates to a grease gun, and more particularly to a grease gun that can be manual operated and pneumatic operated.

2. Description of Related Art

Grease is widely used in the machinery field for lubrication. However, the grease usually is very sticky and does not be easily and equally applied on the elements. Consequently, a grease gun is provided for easily applying grease.

However, the conventional grease gun is either manual or pneumatic. In addition, the manual grease gun and the pneumatic grease gun do not be replaced each other. As a result, the conventional grease guns have several disadvantages as follow.

1. Pneumatic grease gun: the operation must be stopped when the air compressor or the pneumatic grease gun has a breakdown and the air compressor or the pneumatic grease gun may not be restored at once. Consequently, the operation is delayed.

2. Manual grease gun: the manual grease gun has a low fault rate. However, the operator's hand may feel ache when operating the manual grease gun for a period of time.

3. It may be wasted on cost of operation to prepare two grease guns with different type for avoiding the above disadvantages.

The present invention has arisen to mitigate and/or obviate the disadvantages of the conventional grease guns.

### SUMMARY OF THE INVENTION

The main objective of the present invention is to provide an improved grease gun that can be used as a manual type or a pneumatic type.

To achieve the objective, the grease gun in accordance with the present invention comprises a hollow body having a joint formed on the middle section of the hollow body and a grease container is mounted to the joint for containing grease. A pump unit is mounted to the rear end of the hollow body and an outlet unit is mounted to the front end of the hollow body, whereby the pump unit is replaceable and operated to form a pressure difference between the hollow body and the grease container such that the grease in the grease container is drawn into the hollow body from the grease container and discharged via the outlet unit.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a grease gun in accordance with the present invention;

FIG. 2 is a cross-sectional view of the grease gun in FIG. 1;

FIG. 3 is an exploded view of the grease gun in FIG. 1;

FIG. 4 is a perspective view of a second embodiment of the grease gun in accordance with the present invention;

FIG. 5 is a cross-sectional view of the grease gun in FIG. 4; and

FIG. 6 is an exploded view of the grease gun in FIG. 4.

### DETAILED DESCRIPTION OF THE INVENTION

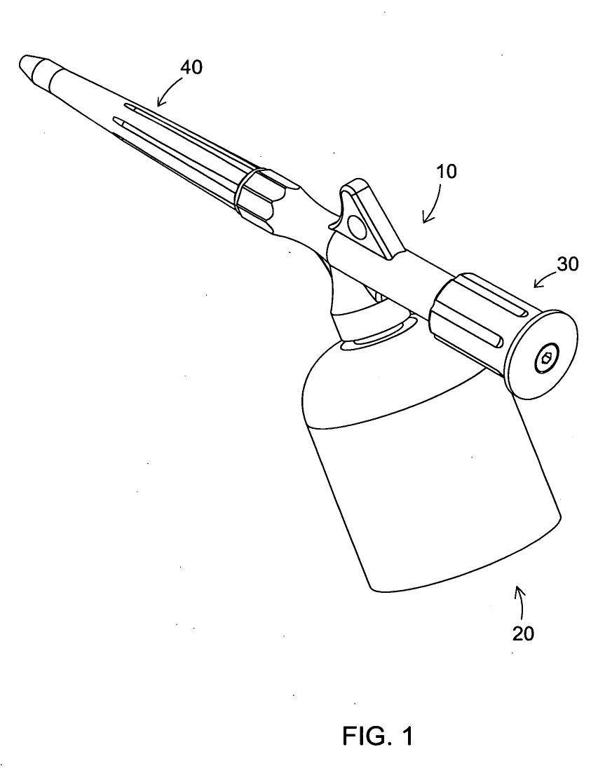

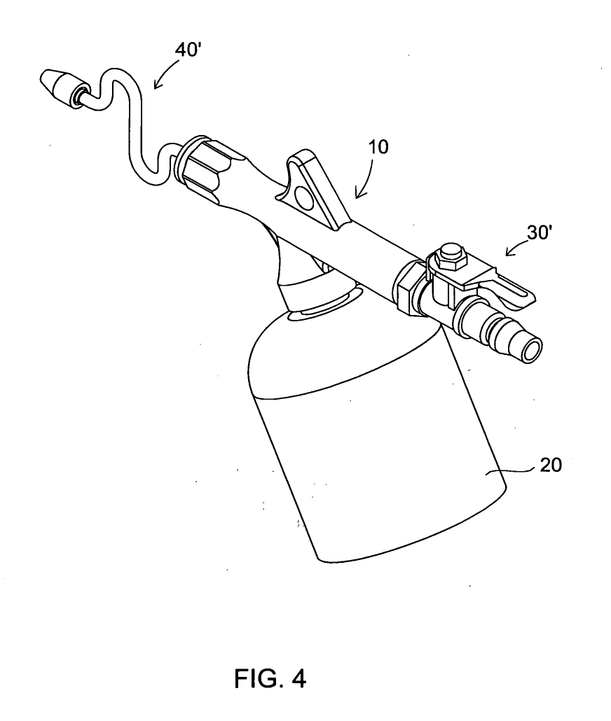

Referring to the drawings and initially to FIGS. 1 and 4, a grease gun in accordance with the present invention can be manual or pneumatic. The grease gun of the present invention comprise a hollow body (10), a grease container (20) mounted to a middle section of the hollow body (10), a pump unit (30/30′) longitudinally mounted to a rear end of the hollow body (10) and an outlet unit (40/40′) longitudinally mounted to a front end of the hollow body (10). The push units (30, 30′) can be replaced to each other to achieve the objective of manual operation and pneumatic operation.

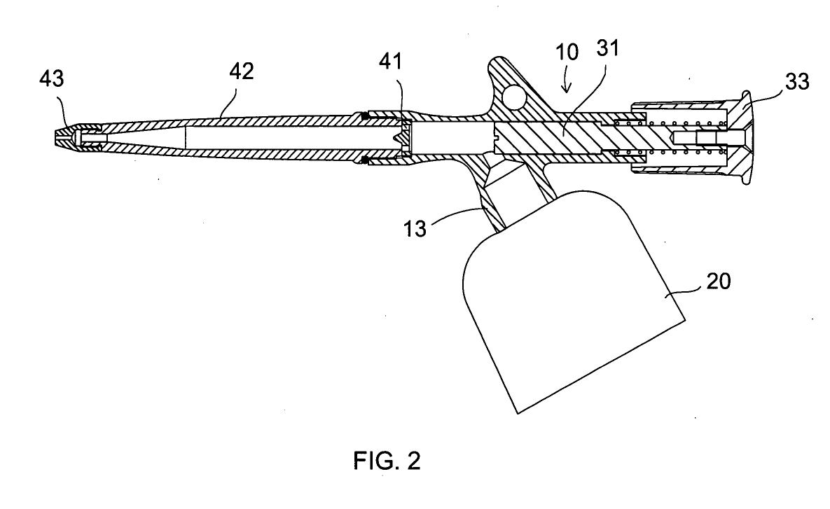

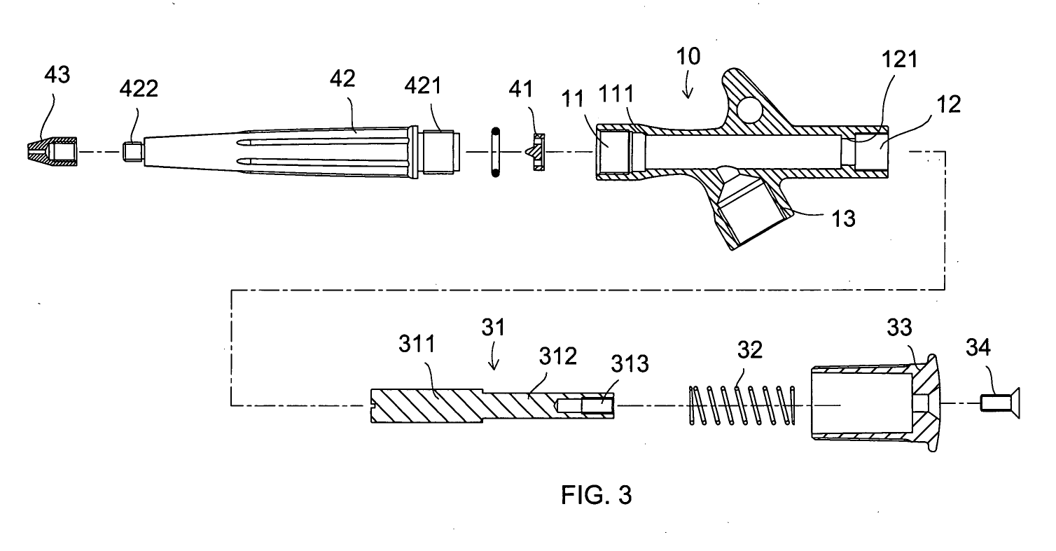

With reference to FIGS. 1-3 that show a manual embodiment of the present invention. A first threaded hole (11) and a second threaded hole (12) respectively longitudinally defined in a front end and a rear end of the hollow body (10) and communicating with an inner periphery of the hollow body (10). A shoulder (111) is formed on a bottom of the first threaded hole (11) and an annular flange (121) extends from the inner periphery of the hollow body (10) near a bottom of the second threaded hole (12). A joint (13) is formed on the middle section of the hollow body (10) for mounting the grease container (20).

The pump unit (30) comprises a piston (31) reciprocally movably received in the hollow body (10). The piston (31) is divided into a first section (311) and a second section (312), wherein the first section (311) has a diameter greater than that of the second section (312). Consequently, the first section (311) of the piston (31) can engaged to the annular flange (121) to prevent the piston (31) from detaching from the hollow body (10). The second section (312) of the piston (31) extends through the rear end of the hollow body (10) via a through hole (not numbered) defined by the annular flange (121) and the second threaded hole (12). A threaded hole (313) is longitudinally defined in a distal end of the second section (312) of the piston (31). A spring (32) is sleeved on the second section of the piston (31) and a cap (33) is mounted to the distal end of the second section (312) of the piston (31), wherein the cap (33) reciprocally drives the piston (31) and the spring (32) has two opposite ends respectively abutting the annular flange (121) and the cap (33) for providing a restitution force to the cap (33). A bolt (34) centrally extends through the cap (33) and is screwed into the threaded hole (313) to hold the cap in place.

The outlet unit (40) comprises a discharge damping (41) abutting the shoulder (111) of the hollow body (10) for controlling the discharge rate of the grease gun and a tube (42) longitudinally mounted to the front end of the hollow body (10) to hold the discharge damping (41) in place. A first threaded portion (421) and a second threaded portion (422) are respectively formed on a rear end and a front end of the tube (42). The first threaded portion (421) is screwed into the first threaded hole (11) in the hollow body (10) and a nozzle (43) is crewed onto the second threaded portion (422) of the tube (42).

When operating the manual embodiment of the grease gun in accordance with the present invention, the user only needs to continuously the cap (33) for reciprocally driving piston (31) in the hollow body (10) to form a pressure difference between the hollow body (10) and the grease container (20) such that the grease in the grease container (20) is drawn into the hollow body (10) from the grease container (20) and discharged via the tube (42) and the nozzle (43) to lubricate elements.

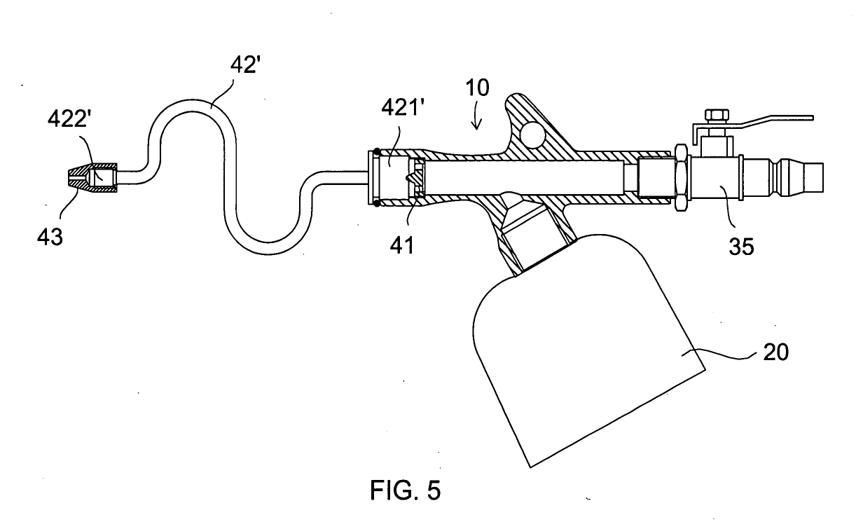

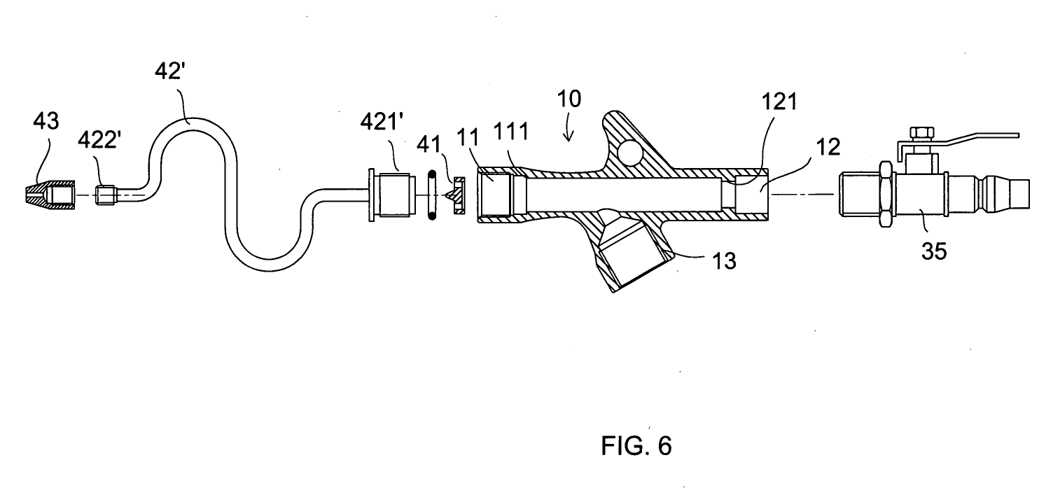

With reference to FIGS. 4-6 that show a pneumatic embodiment of the grease gun in accordance with the present invention, the hollow body (10) of the embodiment is the same as that of the manual embodiment as described above. The pump unit (30′) comprises a pneumatic faucet (35) having one end screwed into the second threaded hole (12) in the hollow body (10). The pneumatic faucet (35) is adapted to be connected to a high pressure air source (not shown), such as an air compressor. In the embodiment, the tube (42′) is made of flexible material for a convenient operation. The tube (42′) has two opposite ends respectively formed with a first thread joint (421′) and a second thread joint (422′). The first thread joint (421′) is screwed into the first threaded hole (11) to hold the discharge damping (41) in place and nozzle (43) is screwed onto the second thread joint (422′).

When operating the manual embodiment of the grease gun in accordance with the present invention, the pneumatic faucet (35) is operated to allow the high pressure air flowing into the hollow body (10) to form a pressure difference between the hollow body (10) and the grease container (20) such that the grease in the grease container (20) is drawn into the hollow body (10) from the grease container (20) and discharged via the tube (42′) and the nozzle (43) to lubricate elements.

As described above, the pump units (30, 30′) are replaceable such that the grease gun of the present invention can be used as a manual type and a pneumatic type. As a result, the using scope of the grease gun is widened.

Although the invention has been explained in relation to its preferred embodiment, it is to be understood that many other possible modifications and variations can be made without departing from the spirit and scope of the invention as hereinafter claimed.

What is claimed is:

1. A grease gun comprising:
a hollow body including a first threaded hole and a second threaded hole respectively longitudinally defined in a front end and a rear end of the hollow body, the first threaded hole and the second threaded hole respectively communicating with an inner periphery of the hollow body, a shoulder formed on a bottom of the first threaded hole and an annular flange extending from the inner periphery of the hollow body near a bottom of the second threaded hole, a joint formed on the middle section of the hollow body;
a grease container mounted to the joint of the hollow body for containing grease;
a pump unit mounted to the rear end of the hollow body; and
a outlet unit mounted to the front end of the hollow body;
whereby the pump unit is operated to form a pressure difference between the hollow body and the grease container such that the grease in the grease container is drawn into the hollow body from the grease container and discharged via the outlet unit.

2. The grease gun as claimed in claim 1, wherein the pump unit comprises a piston reciprocally movably received in the hollow body, the piston divided into a first section and a second section, wherein the first section has a diameter greater than that of the second section such that the first section of the piston is engaged to the annular flange to prevent the piston from detaching from the hollow body, the second section of the piston extending through the rear end of the hollow body via a through hole defined by the annular flange and the second threaded hole, a spring sleeved on the second section of the piston and a cap mounted to a distal end of the second section of the piston, wherein the cap reciprocally drives the piston and the spring has two opposite ends respectively abutting the annular flange and the cap for providing a restitution force to the cap.

3. The grease gun as claimed in claim 2, wherein pump unit comprises a pneumatic faucet having one end screwed into the second threaded hole in the hollow body, the pneumatic faucet adapted to be connected to a high pressure air source and allowing the high pressure air flowing into the hollow body.

4. The grease gun as claimed in claim 1, wherein the outlet unit comprises a discharge damping abutting the shoulder of the hollow body for controlling the discharge rate of the grease gun and a tube longitudinally mounted to the front end of the hollow body to hold the discharge damping in place, a first threaded portion and a second threaded portion respectively formed on a rear end and a front end of the tube, the first threaded portion screwed into the first threaded hole in the hollow body and a nozzle crewed onto the second threaded portion of the tube.

5. The grease gun as claimed in claim 2, wherein the piston has a threaded hole longitudinally defined in a distal end of the second section thereof, and a bolt centrally and longitudinally extending through the cap and screwed into the threaded hole in the piston to hold the cap in place.

6. The grease gun as claimed in claim 2, wherein the outlet unit comprises a discharge damping abutting the shoulder of the hollow body for controlling the discharge rate of the grease gun and a tube longitudinally mounted to the front end of the hollow body to hold the discharge damping in place, a first threaded portion and a second threaded portion respectively formed on a rear end and a front end of the tube, the first threaded portion screwed into the first threaded hole in the hollow body and a nozzle crewed onto the second threaded portion of the tube.

7. The grease gun as claimed in claim 3, wherein the outlet unit comprises a discharge damping abutting the shoulder of the hollow body for controlling the discharge rate of the grease gun and a tube longitudinally mounted to the front end of the hollow body to hold the discharge damping in place, a first threaded portion and a second threaded portion respectively formed on a rear end and a front end of the tube, the first threaded portion screwed into the first threaded hole in the hollow body and a nozzle crewed onto the second threaded portion of the tube.

8. The grease gun as claimed in claim 4, wherein the tube is made of flexible material for a convenient operation.

9. The grease gun as claimed in claim 6, wherein the tube is made of flexible material for a convenient operation.

10. The grease gun as claimed in claim 7, wherein the tube is made of flexible material for a convenient operation.
